(19) United States
(12) Patent Application Publication
(10) Pub. No.: US 2024/0151046 A1
(43) Pub. Date: May 9, 2024

(54) ADJUSTABLE PLATFORM RAIL SYSTEMS AND METHODS

(71) Applicant: Oshkosh Corporation, Oshkosh, WI (US)

(72) Inventors: Greg Shafer, Oshkosh, WI (US); Dan Ippolito, Oshkosh, WI (US); Devin Rosencrance, Oshkosh, WI (US); Neil Harris, Oshkosh, WI (US); Jonathan Dawson, Oshkosh, WI (US); Morten Ellis, Oshkosh, WI (US)

(73) Assignee: Oshkosh Corporation, Oshkosh, WI (US)

(21) Appl. No.: 18/411,925

(22) Filed: Jan. 12, 2024

Related U.S. Application Data
(63) Continuation of application No. 17/193,076, filed on Mar. 5, 2021, now abandoned.
(60) Provisional application No. 62/985,953, filed on Mar. 6, 2020.
(60) Provisional application No. 63/032,873, filed on Jun. 1, 2020.

(51) Int. Cl. E04G 5/14; B66F 11/04; E04G 1/34

(52) U.S. Cl. CPC E04G 5/142; B66F 11/042; E04G 1/34; E04G 5/14

(57) ABSTRACT

Systems and apparatuses an adjustable platform rail assembly. The adjustable platform rail assembly includes a lower rail assembly and an upper rail assembly. The lower rail assembly extends away from a platform of a mobile elevated work platform to define a passenger compartment therein. The upper rail assembly is coupled to the lower rail assembly and extends upwardly away from the lower rail assembly. The upper rail assembly includes a perimeter space assembly and a confined space assembly. The upper rail assembly is movable between (a) a first configuration in which the perimeter rail assembly and the confined space assembly are extended and the upper rail assembly surrounds the passenger compartment, and (b) a second configuration in which the perimeter rail assembly is collapsed, the confined space assembly is extended, and the upper rail assembly surrounds a subset of the passenger compartment.

### CROSS-REFERENCE TO RELATED APPLICATIONS

This application is a continuation of U.S. patent application Ser. No. 17/193,076, filed Mar. 5, 2021, which claims priority to U.S. Provisional Patent Application No. 62/985,953, filed Mar. 6, 2020, and U.S. Provisional Patent Application No. 63/032,873, filed Jun. 1, 2020, the contents of which are hereby incorporated by reference in their entireties.

### BACKGROUND

Mobile elevated work platforms (MEWPs) are used to perform tasks at different heights and locations. Completing tasks in narrow spaces like ceiling grids can be difficult when the MEWP has a platform that is wider or longer than the narrow space, which limits the allowable vertical travel of the platform. To reach the desired working height, a worker may need to use a ladder or footstool positioned on the platform, which can have several drawbacks.

### SUMMARY

One exemplary embodiment relates to an adjustable platform rail assembly. The adjustable platform rail assembly includes a lower rail assembly and an upper rail assembly. The lower rail assembly is configured to extend away from a platform of a mobile elevated work platform, such as a scissor lift. The upper rail assembly is coupled to the lower rail assembly and extends upwardly away from the lower rail assembly to define a passenger compartment therein. The upper rail assembly is coupled to the lower rail assembly and is movable between a first position where the upper rail assembly defines an upper perimeter defined by a first length and a second position where the upper rail assembly defines an upper perimeter defined by a second length that is shorter than the first length.

Another exemplary embodiment relates to a scissor lift. The scissor lift includes a base, an actuator, a retractable lifting mechanism, a platform assembly, and an adjustable platform rail assembly. The retractable lifting mechanism extends away from the base and is movable away from the base by the actuator. The platform assembly is positioned at one end of the retractable lifting mechanism and is configured to move vertically relative to the base in response to movement by the actuator. The adjustable platform rail assembly extends away from the platform, and includes a lower rail assembly and an upper rail assembly. The lower rail assembly extends away from the platform assembly. The upper rail assembly is coupled to the lower rail assembly and extends upwardly away from the lower rail assembly to define a passenger compartment. The upper rail assembly is movable between a first position and a second position. More of the upper rail assembly is positioned within an outer perimeter defined by the lower rail assembly in the second position than in the first position, which reduces the size of the passenger compartment.

Another exemplary embodiment relates to a lift. The lift includes a base, an actuator, a retractable lifting mechanism, a platform assembly, and a cage. The retractable lifting mechanism extends away from the base and is movable away from the base by the actuator. The platform assembly is positioned at one end of the retractable lifting mechanism and is configured to move vertically relative to the base in response to movement by the actuator. The cage is positioned on the platform, and is movable relative to the platform along a first axis to adjust a position of the cage relative to the platform. The cage can be movable vertically and/or horizontally about the platform and relative to a rail assembly, if present, to allow the cage to extend upwardly into confined spaces that might otherwise be inaccessible by the MEWP, due to the size of the platform assembly.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top perspective view of a lift device, according to an exemplary embodiment;

FIG. 2 is a top perspective view of a platform and adjustable rail system of the lift device of FIG. 1;

FIG. 3 is another top perspective view of the platform and adjustable rail system of FIG. 2;

FIG. 4 is a side view of the platform and adjustable rail system of FIG. 2;

FIG. 5 is another top perspective view of the platform and adjustable rail system of FIG. 2;

FIG. 6 is a perspective view of the platform and adjustable rail system of FIG. 2, folded into a narrow space operational mode;

FIG. 7 is a top perspective view of the platform and adjustable rail system of FIG. 6;

FIG. 8 is a side view of the platform and adjustable rail system of FIG. 6;

FIG. 9 is a top perspective view of the platform and adjustable rail system of FIG. 6;

FIG. 10 is another top perspective view of the platform and adjustable rail system of FIG. 6;

FIG. 11 is another top perspective view of the platform and adjustable rail system transitioned out of the narrow space operational mode to a normal operational mode;

FIG. 12 is another top perspective view of the platform and adjustable rail system transitioned out of the normal operational mode to a travel operational mode;

FIG. 13 is a top perspective view of the platform and adjustable rail system of FIG. 2 with the platform in an extended position and the adjustable rail system in the normal operational mode;

FIG. 14 is a top perspective view of the platform and adjustable rail system of FIG. 13 with the platform in an extended position and the adjustable rail system in the narrow space operational mode;

FIG. 15 is a top perspective view of the platform and adjustable rail system of FIG. 2 with the platform in a partially extended position and the adjustable rail system in the normal operational mode;

FIG. 16 is a top perspective view of the platform and adjustable rail system of FIG. 15 with the platform in a partially extended position and the adjustable rail system in the narrow space operational mode;

FIG. 17 a pictorial view of the lift device of FIG. 1, extending upward into a narrow space within a ceiling grid;

FIG. 18 is another pictorial view of the lift device of FIG. 17;

FIG. 19 is a pictorial view of the lift device of FIG. 1, extending upward into a narrow space within plumbing;

FIG. 20 is another pictorial view of the lift device of FIG. 19;

FIG. 21 is a perspective view of a lift device, according to another exemplary embodiment, with an accessory in a first, stowed position;

FIG. 22 is another perspective view of the lift device of FIG. 21, with the accessory in a second, deployed position;

FIG. 23 is a partially exploded perspective view of the accessory on the lift of FIG. 23;

FIG. 24 is a perspective view of the accessory on the lift of FIG. 23, shown in the second, deployed position;

FIG. 25 is a perspective view of a lift device, according to another exemplary embodiment;

FIG. 26 is a perspective view of the lift device of FIG. 25 with a rail assembly removed;

FIG. 27 is a detailed view of a roller and track arrangement along a platform of the lift device of FIG. 26;

FIG. 28 is a perspective view of the lift device of FIG. 27, with an accessory installed;

FIG. 29 is a detailed view of a positioning mechanism that is used to adjust a relative position between the accessory of FIG. 28 and the platform of the lift; and

FIG. 30 is a perspective view of the lift device of FIG. 28, with a locking mechanism.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to ceiling grid access systems including adjustable platform rail systems, apparatuses, and methods. The adjustable platform rail systems can take on a variety of different forms that allow a user to more readily access enclosed areas that may be smaller than an overall size of the platform and different to access with a traditional lift.

For example, the adjustable platform rail systems can include a series of folding and hinged segments that allow a user to adjust the height and position of the rail systems depending on the desired task to be performed. The adjustable platform rails systems include a perimeter assembly extending around a portion of the perimeter of the platform and a confined space assembly positioned on one end of the platform and coupled to the perimeter assembly. The adjustable rail systems can transition between a normal operational mode and a narrow space operational mode. In the normal operational mode, the guard rails within each of the perimeter assembly and the confined space assembly are deployed around the entire perimeter of the work platform, which allows a worker to use and perform tasks at any location on the platform. If a task needs to be performed within a confined or obstructed area, a worker can transition the guard rails to the narrow space operational mode. The guard rails are transitioned to the narrow space operational mode by folding the perimeter assembly downward. Folding the guard rails within the perimeter assembly reduces the overall height of the guard rails within the perimeter assembly, but leaves the confined space assembly in its fully deployed configuration. With only the confined space assembly deployed and extending above the folded perimeter assembly, a worker positioned on the platform within the confined space assembly can be elevated further into the narrow space because the rails within the perimeter assembly will not contact or otherwise interfere with the ceiling grid as the platform is raised. By avoiding guard rail interference with the ceiling grid or other obstacles, a standard platform can be used to reach higher locations. The adjustable platform rail systems eliminate many of the problems typically associated with MEWPs and allow workers to perform tasks at higher locations within narrow spaces without the use of a ladder, scaffold, step stool, or other auxiliary access assembly.

In some examples, the adjustable platform rail systems include an accessory that is movable along the platform. The accessory can be a cage that is received within the outer perimeter of the rail assembly. The cage can be movable vertically and/or horizontally relative to the platform using a variety of different features. For example, the cage can include a scissor jack that is configured to adjust a height of the cage relative to the platform below. When the scissor jack and lift system extend upwardly, at least a portion of the cage can extend vertically above the perimeter of the rail assembly. Accordingly, a worker positioned on a base panel of the cage can be elevated upwardly away from the platform and into a confined area that might otherwise be inaccessible, based on size requirements of the perimeter of the platform rail assembly.

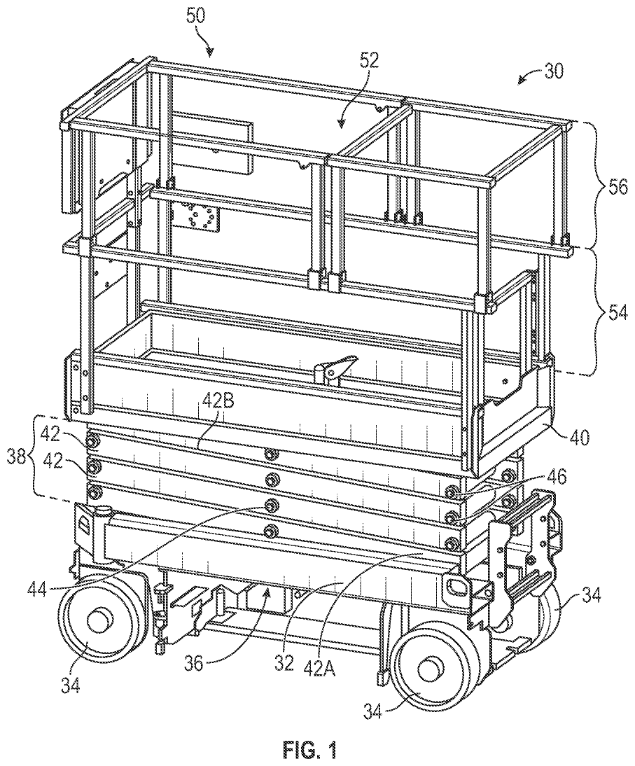

Referring to FIG. 1, a MEWP 30 is shown. The MEWP 30 can be a scissor lift or boom lift, for example, which can be used to perform a variety of different tasks at various heights relative to the ground below. The MEWP 30 includes a base, shown as chassis 32 that supports wheels 34 positioned about the base. The wheels 34 can be driven by a prime mover 36 (e.g., an electric motor, and internal combustion engine, a hybrid engine, hydraulic drive, etc.) to propel the MEWP 30 to a desired location for completing a task.

A retractable lifting mechanism 38 is coupled to the chassis 32 and supports a platform 40. As depicted in FIG. 1, the retractable lifting mechanism 38 is a scissor lift structure formed of a series of linked, foldable support members 42 connected to one another using central pivot pins 44 and outer pivot pins 46. The central pivot pins 44 and outer pivot pins 46 extend through adjacent support members 42 to pivotally couple the support members 42 in an assembly. The support members 42 include lowermost foldable support members 42A pivotally coupled to the base 32 and uppermost foldable support members 42B pivotally coupled to an underside of the platform 40.

Adjusting the angular relationships between adjacent support members 42, 42A, 42B pivots the lowermost foldable support members 42A and other support members 42, 42B away from the chassis 32 and away from one another, which alters the position of the platform 40 relative to the base 32. By altering the position (e.g., the height) of the platform 40 relative to the chassis 32, workers can be elevated to different vertical locations to complete tasks from on the platform 40. The foldable support members 42 of the retractable lifting mechanism 38 are folded or unfolded using an actuator 48, such as a hydraulic cylinder, pneumatic cylinder, or electric linear actuator, for example. The actuator 48 controls the position of the retractable lifting mechanism 38 and platform 40 by selectively applying force to the lifting mechanism 38, which occurs by changing a length of the actuator 48. For example, extending the actuator 48 will raise the foldable support members 42 and platform 40 and retracting the actuator will lower the foldable support members 42 and platform 40.

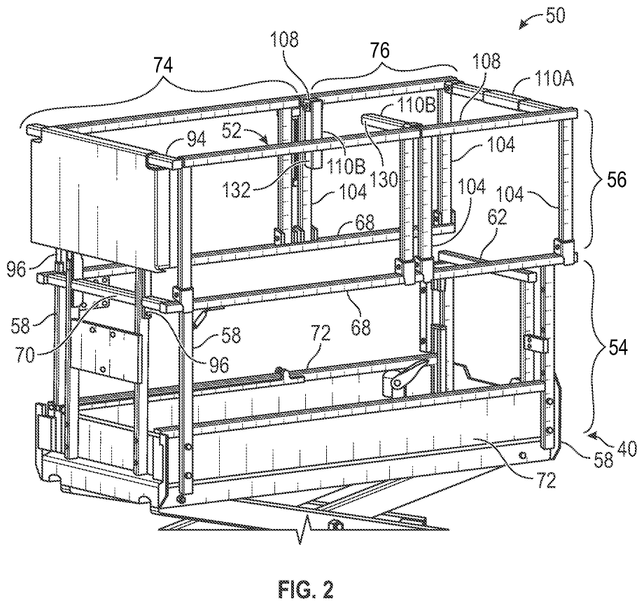

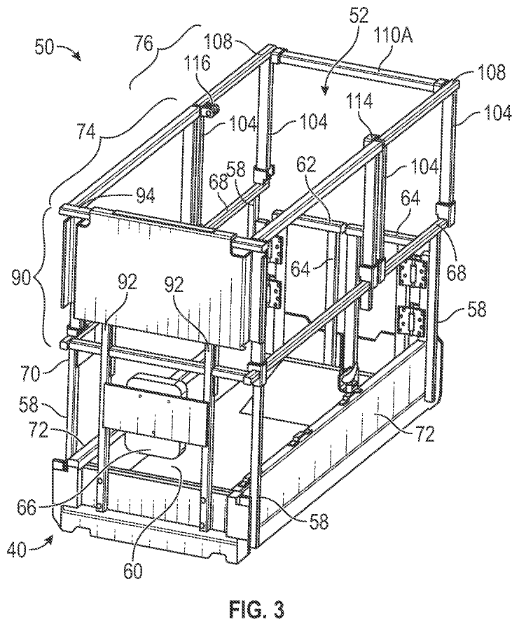

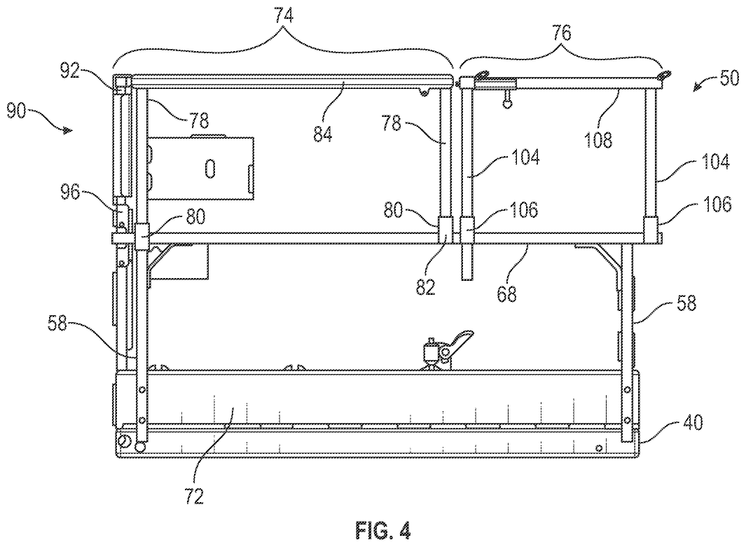

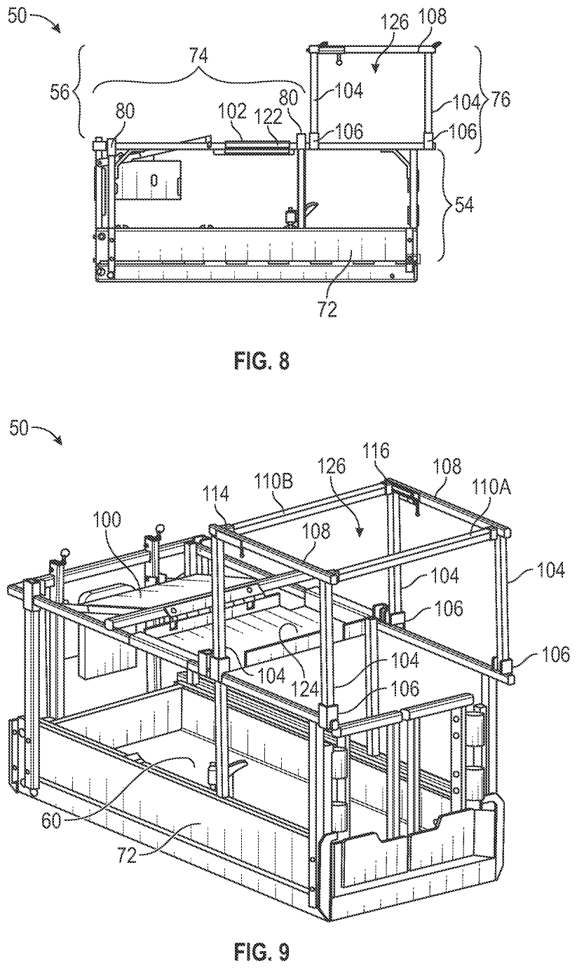

With additional reference to FIGS. 2-9, the platform 40 supports and is surrounded by an adjustable platform rail assembly 50. The adjustable platform rail assembly 50 extends away from the platform 40 and is defined by a generally rectangular shape that extends around a perimeter of the platform 40 to define a passenger compartment 52 above the platform 40. The adjustable platform rail assembly 50 can be rigidly (e.g., welded) or removably (e.g., pin and bracket mounted) coupled to a perimeter of the platform 40.

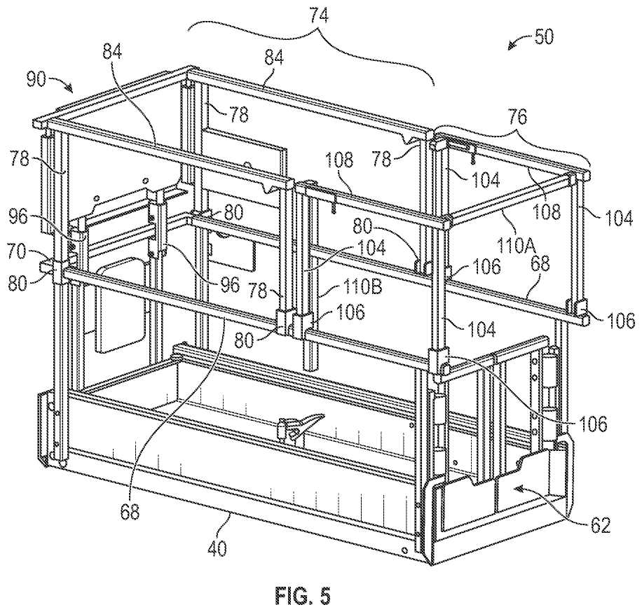

The adjustable platform rail assembly 50 generally includes a lower rail assembly 54 and an upper rail assembly 56 coupled to the lower rail assembly 54. The lower rail assembly 54 is at least partially formed by vertical rails 58 that extend upwardly from the platform 40. In some examples, the vertical rails 58 extend upwardly from positions approximately adjacent to each corner of the rectangular platform 40. The vertical rails 58 extend upwardly from the platform 40, approximately perpendicular (e.g., +/−15 degrees) to a top, operator-supporting surface 60 of the platform 40. In some examples, a gate 62 formed of rotatable doors 64 can extend between two of the vertical rails 58 of the lower rail assembly 54. Opposite the gate 62, the vertical rails 58 can support a control panel 66 that can be used to control the actuator 48 or motor 36 to help position the platform 40 at a desired working location. The lower rail assembly 54 is further defined by cross rails 68, 70 that extend from and between the tops of the vertical rails 58. As depicted in FIG. 5, a cross rail can be omitted from the two vertical rails 58 that support the gate 62.

Additional supporting members can be used to further fortify the lower rail assembly 54. For example, floor panels 72 can span between and be coupled to each of the vertical rails 58. The floor panels 72 extend upwardly from each side of the platform 40, and create a box-like support structure for the vertical rails 58 that helps maintain the vertical rails 58 in a perpendicular orientation relative to the operator-supporting surface 60 of the platform 40. In some examples, one of the floor panels 72 forms part of the gate 62, and has a discontinuous structure to permit hinged rotation of the rotatable doors 64 relative to the vertical rails 58 that the gate 62 is attached to. The floor panels 72 can help contain objects positioned on the operator-supporting surface 60 within the platform 40.

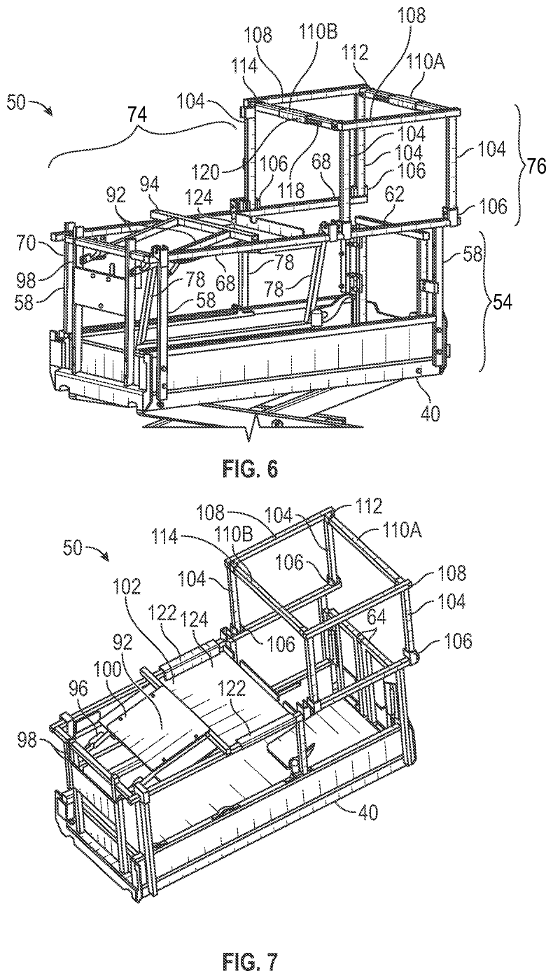

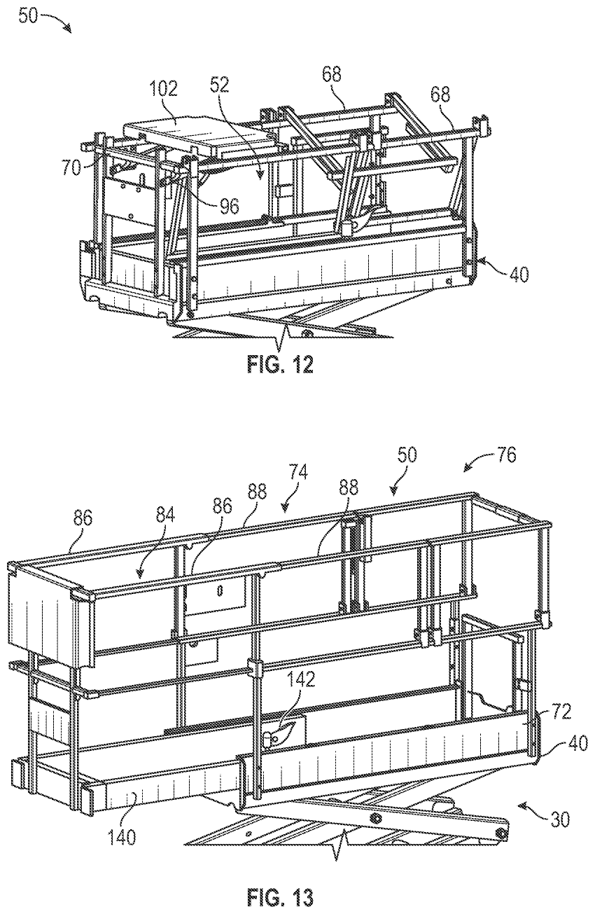

The upper rail assembly 56 is coupled to and extends upwardly away from the lower rail assembly 54. Like the lower rail assembly 54, the upper rail assembly 56 is formed of a series of guard rails that together define the passenger compartment 52. The guard rails are hingedly coupled to the lower rail assembly 54 so that the adjustable platform rail assembly 50 can transition between several operational modes that can be used to perform tasks. As explained in detail below, the upper rail assembly 56 can be manipulated so as to arrange the adjustable platform rail assembly 50 in a normal operational mode (shown in FIGS. 2-5 and 11), a narrow space operational mode (shown in FIGS. 6-10), or a transport mode (shown in FIG. 12). The hinged and/or slidable couplings formed between the upper rail assembly 56 and the lower rail assembly 54 allow the MEWP 30 to accommodate a wide variety of tasks that traditional MEWPs cannot perform.

The upper rail assembly 56 includes rails formed into a perimeter assembly 74 and a confined space assembly 76. The perimeter assembly 74 includes vertical rails 78 extending upwardly away from the cross rails 68, 70. In some examples, a series of brackets 80 are mounted (e.g., welded or bolted) to the cross rails 68, 70 to receive and support the vertical rails 78. The brackets 80 can provide a pivot or hinge joint around which the vertical rails 78 can rotate, relative to the cross rails 68, 70 of the lower rail assembly 54. The brackets 80 can be defined by a brace section 82 that faces outwardly away from the passenger compartment 52. The brace section 82 constrains the allowable rotational motion of the vertical rails 78 so that the vertical rails 78 cannot rotate outwardly beyond an approximately vertical orientation that is perpendicular to the operator-supporting surface 60. The brackets 80 can include pins or similar quick-release locking mechanisms that can maintain the vertical rails 78 in a deployed position (e.g., approximately perpendicular to the operator-supporting surface 60) during platform 40 use. In the deployed position, the vertical rails 78 can extend upward to a height (e.g., about 1.1 meters) compliant with ANSI 92.20. When released or otherwise unlocked, the vertical rails 78 can rotate downwardly and inwardly about the pivot or hinge joints provided by the brackets 80, which allows the vertical rails 78 to hang downwardly from the brackets 80, into the passenger compartment 52. When rotated downwardly and inwardly to the stowed position shown in FIGS. 6-9 and 12, the perimeter assembly 74 can be effectively stored within the confines of the lower rail assembly 54, in a way that does not protrude upwardly beyond the cross rails 68, 70.

Guard rails 84 extend between the vertical rails 78 of the perimeter assembly 74. In some examples, the guard rails 84 are a telescoping assembly of an outer arm 86 and an inner arm 88 that can slide relative to the outer arm 86 when the platform 40 is extended outward (as shown in FIGS. 13-16). The guard rails 84 can be rigidly or removably coupled to two of the vertical rails 78. In some embodiments, one of the vertical rails 78 is coupled to the outer arm 86 and another vertical rail 78 is coupled to the inner arm 88 of the guard rail 84. In such arrangements, the perimeter assembly 74 can extend to the outer perimeter of the platform 40 in both the stowed and deployed configurations.

The perimeter assembly 74 is further defined by an end section 90 positioned at one end of the platform 40. The end section 90 can be positioned opposite the gate 62, and includes vertical support rails 92 and a cross rail 94 extending between the vertical support rails 92. The cross rail 94 can receive or otherwise be releasably secured to the guard rails 84. When the guard rails 84 are coupled to the cross rail 94, the cross rail 94 and guard rails 84 are self-supporting, and maintain each of the vertical rails 78 and the vertical support rails 92 in the approximately vertical and deployed position. When the cross rail 94 is decoupled from the guard rails 84, the side assemblies (e.g., the vertical rails 78 and guard rails 84) can rotate inward toward the stowed position. In some embodiments, pins extend outwardly from both ends of the cross rail 94, which can be engaged and releasably secured by hooks formed on ends of the guard rails 84.

Because the vertical support rails 92 are also hingedly coupled to the cross rail 70, the end section 90 is free to rotate inwardly when the cross rail 94 is decoupled from the guard rails 84, to the stowed position shown in FIGS. 6-9. Additional brackets 96 mounted to the vertical rails 58 and the cross rail 70 can support and constrain inward motion of the end section 90 relative to the lower rail assembly 54. As depicted in FIG. 7, the brackets 96 can be hingedly coupled to the vertical rails 58 and include hooks 98 configured to engage and be seated upon the cross rail 70. The end section 90 can further include one or more work trays 100, 102, as explained in additional detail below.

The confined space assembly 76 is positioned on the lower rail assembly 54, adjacent the perimeter assembly 74. Like the perimeter assembly 74, the confined space assembly 76 is formed of a series of vertical rails 104 that are hingedly coupled to the lower rail assembly 54. The vertical rails 104 extend upwardly away from brackets 106 that are rigidly or removably coupled to the cross rails 68 of the lower rail assembly 54. The brackets 106 are arranged like the brackets 80, which allow rotatable motion between the vertical rails 104 relative to the cross rails 68. The brackets 106 allow inward, folding motion of the vertical rails 104 that enables the confined space assembly to rotate downwardly and inwardly from the deployed position to a stowed, transport mode, as explained below.

Cross rails 108 and restraining rails 110 extend above the vertical rails 104 of the confined space assembly 76. The cross rails 108 can extend between the vertical rails 104 to define the length dimension of the confined space assembly 76, while the restraining rails 110 extend transverse to the cross rails 108, across and above the platform 40. The restraining rails 110 are hingedly and releasably coupled the cross rails 108, and can be used to selectively permit or restrict access onto or about the platform 40. For example, the restraining rail 110A extending along a perimeter can be folded downward and inward, about a bracket 112, so that an operator can enter the passenger compartment 52 through the gate 62 without having to bend over or duck below the restraining rail 110A. Likewise, the restraining rail 110B can be selectively coupled to the cross rails 108 to fully define the confined space assembly 76 when the adjustable platform rail assembly 50 is configured in the narrow space operational mode. In the normal operational mode, the restraining rail 110B can hang downward from a bracket 114 so that the restraining rail 110B extends approximately parallel to the vertical rails 58 of the lower rail assembly 54. In this hanging position, the restraining rail 110B is positioned so that it does not significantly impact a worker's ability to move about the entire platform 40. To transition the confined space assembly 76 to the narrow space operational mode, the restraining rail 110B is rotated upwardly, about the bracket 114, into engagement with a locking mechanism 116 positioned on one or both of the cross rail 108 and the vertical rail 104. The locking mechanism 116 can be a hook and pin or quick release trigger-style latch locking mechanism, for example. In some examples, both restraining rails 110A, 110B are configured to be coupled to the same style of locking mechanism 116.

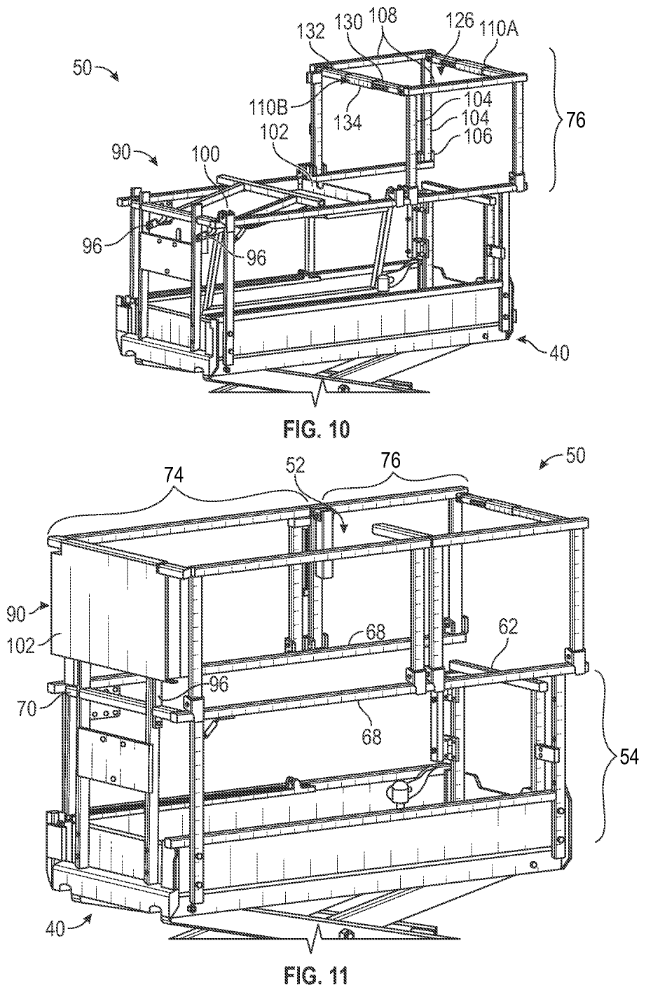

To promote easy transition between the folded position and the deployed positions, the restraining rails 110A, 110B can each be formed as telescoping arm assemblies. As depicted in FIG. 10, the restraining rails can each include an inner arm 118 that is received within and is slidable relative to an outer arm 120. In some examples, the inner arm 118 is biased (e.g., with a spring) inward, into the outer arm 120. When the restraining rails 110A, 110B are preferably coupled to the cross rails 108, an operator can provide a tensile force on one of the arms 118, 120. If the tensile stretching force on the arm 118, 120 overcomes the spring force biasing the arms 118, 120 together, the outer arm 120 will move relative to the inner arm 118, which increases the length of the restraining rail 110. The stretching force can be applied to the restraining rail 110 until it achieves a length necessary to span between the cross rails 108 and engage the locking mechanism 116. The locking mechanism 116 can maintain the restraining rail 110 in its extended position. Releasing the tension on the restraining rails 110 allows the arms 118, 120 to return to their resting position, which reduces the length of the restraining rail 110 and helps promote a more compact storage. Alternatively, and as depicted in FIGS. 10-12, the restraining rails 110 can each be formed of two separate links 130, 132 that are each hingedly coupled to one of the cross rails 108. The links 130, 132 can be rotated upwardly about the cross rails 108, into engagement with one another. In some examples, a coupling sleeve 134 can receive and retain the links 130, 132 together in an orientation approximately parallel to the operator-supporting surface 60 below.

The confined space assembly 76 is arranged in a square-like configuration having a perimeter that is sized to fit within and be received within an opening in a traditional ceiling grid. Accordingly, each of the length dimension (e.g., as defined by the cross rails 108) and width dimension (e.g., as defined by the restraining rails 110) of the confined space assembly 76 is less than about 24 inches. Alternatively, the confined space assembly 76 can be designed to fit within an opening defined by two adjacent openings in the ceiling grid. In such examples, the confined space assembly 76 can be defined by a width of about 25 inches and a length of about 28.3 inches.

By being arranged as described above, the adjustable platform rail assembly 50 can transition through a series of operational modes that help the MEWP 30 readily perform tasks that may otherwise require the use of additional access equipment or expensive retrofit assemblies. As explained below, the adjustable platform rail assembly 50 can be transitioned between a normal operational mode, a narrow space operational mode, and a transport mode that significantly improve the functionality and portability of the MEWP 30.

With reference to FIGS. 2-5 and 11, the platform 40 and the adjustable platform rail assembly 50 are positioned in the “normal” operational mode. In the normal operational mode, each of the perimeter assembly 74 and the confined space assembly 76 are deployed. Accordingly, each of the vertical rails 78, 104 extend upwardly away from the lower rail assembly 54, approximately perpendicular to the operator supporting surface 60 on the platform 40. The vertical rails 78, 104 can be locked in the perpendicular orientation by the brackets 80, 106 or by engagement between the guard rails 84 and cross rail 94 and the cross rails 108 and the restraining rail 110A.

In the normal operational mode, the adjustable platform rail assembly 50 is oriented so that a worker on the platform 40 can make use of the entire operator supporting surface 60. The cross rail 94, guard rails 84, cross rails 108, and restraining rail 110A define a rectangular upper perimeter that extends above the platform 40 at a height of at least about 1.1 meters, for example, in compliance with ANSI 92.20. As depicted, each of the perimeter assembly 74 and the confined space assembly 76 are adjacent to one another on the lower rail assembly 54 but operate independently of one another. To gain access into the passenger compartment 52, a worker can open the gate 62 and decouple the restraining rail 110A from one of the cross rails 108 and the locking mechanism 116. Once the worker is positioned within the passenger compartment 52, the worker can recouple the restraining rail 110A to the locking mechanism 116 and cross rails 108. The actuator 48 can then be used to raise the retractable lifting mechanism 38 and platform 40 away from the base 32 of the MEWP 30 to perform tasks at various heights.

When a task needs to be performed within a narrow or otherwise obstructed space, the adjustable platform rail assembly 50 can be adjusted from the normal operational mode, shown in FIGS. 2-5, to the narrow space operational mode shown in FIGS. 6-10. To transition the adjustable platform rail assembly 50 to the narrow space operational mode, the guard rails 84 are decoupled from the cross rail 94. As explained above, the cross rail 94 can include and support a quick release mechanism (e.g., with a trigger-latch mechanism or a hook and pin system) that allows the guard rails 84 to be quickly disengaged from the cross rail 94.

With the guard rails 84 disengaged from the cross rail 94, the side assemblies of the perimeter assembly 74 can be folded downwardly and inwardly. Without support from the cross rail 94, the vertical rails 78 can each rotate about their respective brackets 80, into the passenger compartment 52 and to a stowed position. Because the guard rails 84 are coupled to the vertical rails 78, the rotation of the vertical rails 78 about the brackets 80 likewise swings the guard rails 84 into a stowed position near the operator-supporting surface 60 below.

With the side assemblies of the perimeter assembly 74 folded into the passenger compartment 52, the end section 90 can be folded downwardly and inwardly into the passenger compartment 52 as well. The vertical rails 92 and cross rail 94 rotate about the hinge joint created by the brackets 96, downward toward the lower rail assembly 54.

The end section 90 of the perimeter assembly 74 can help a worker positioned within the confined space assembly 76 perform tasks by providing a series of support surfaces for storing tools and other equipment for a task when the adjustable platform rail assembly 50 is in the narrow space operational mode. The cross rail 94 extends outwardly, beyond both cross rails 68 of the lower assembly 54. Because the cross rail 94 is wider than the gap between the cross rails 68, downward rotation of the end section 90 causes the cross rail 94 to engage and be seated upon each of the cross rails 68. With the cross rail 94 seated on the cross rails 68, the work trays 100, 102 can be unfolded. As depicted, the work tray 102 includes channel-shaped flanges 122. The flanges 122 extend along a portion of the length of the work tray 102 and are sized to receive and engage the cross rails 68. When the flanges 122 engage the cross rails 68, a working surface 124 of the work tray 102 is maintained in a flat orientation that extends approximately parallel to the operator-supporting surface 60 below. The work tray 102 can extend to a position approximately adjacent to the confined space assembly 76 so that a worker positioned within the confined space assembly 76 can reach and interact with items stored on the work tray 102.

To complete the transition to the narrow space operational mode, the restraining rail 110B is rotated upward into engagement with both of the cross rails 108. As explained above, the restraining rail 110B can rotate about the bracket 114, be stretched or otherwise adjusted to the appropriate length to span across the cross rails 108, and placed into engagement with the locking mechanism 116 on the opposite cross rail 108. By engaging the restraining rail 110B with the locking mechanism 116 and opposite cross rail 108, the confined space assembly 76 creates a full perimeter of guard rails positioned at or above about 1.1 meters, for example, in compliance with ANSI 92.20. Accordingly, a second and smaller passenger compartment 126 is defined for use in confined spaces.

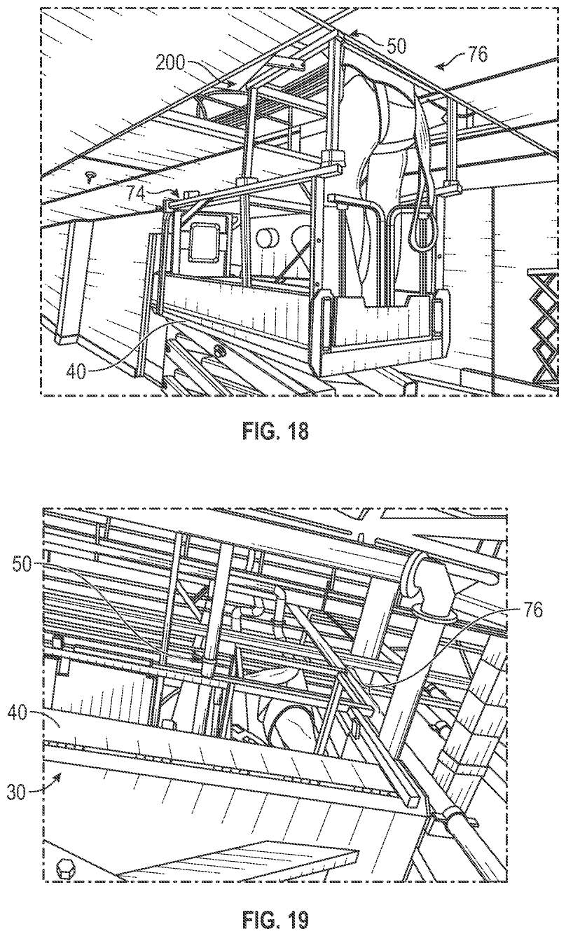

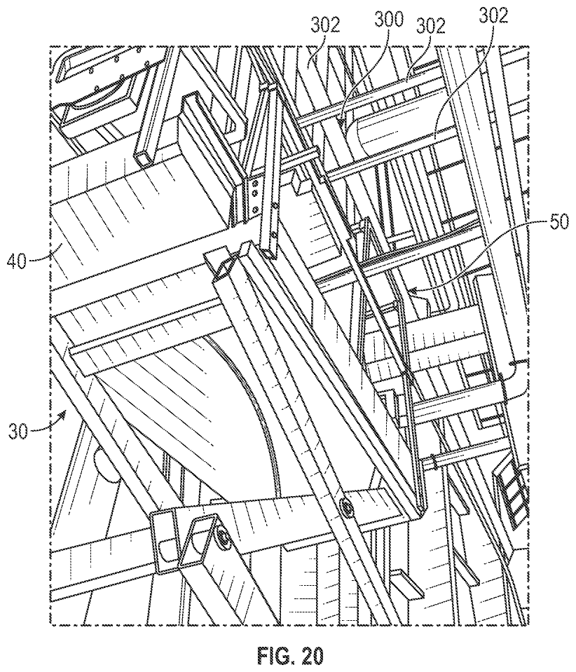

With the adjustable platform rail assembly 50 oriented in the narrow space operational mode, the platform 40 can reach heights and locations that may otherwise be unreachable. As depicted in FIGS. 17-20, having only a portion of the adjustable platform rail assembly 50 (e.g., the confined space assembly 76) deployed limits the possible interference between the adjustable platform rail assembly 50 and an obstruction (e.g., a ceiling grid) that may otherwise prevent the platform 40 from reaching a suitable height for completing a task. If the perimeter assembly 74 of the adjustable platform rail assembly 50 was deployed (e.g., such that the adjustable platform rail assembly 50 was positioned in the normal operational mode), the upper perimeter of the adjustable platform rail assembly 50 may engage the ceiling grid 200, for example, which would prevent further upward travel of the platform. Because only the confined space assembly 76 extends upward from the lower rail assembly 54 in the narrow space operational mode, the platform 40 can be lifted higher than in the normal operational mode. Interference between the adjustable platform rail assembly 50 and the ceiling grid 200 will not occur until the cross rails 68, 70 reach the ceiling grid 200. By reducing the upper perimeter of the adjustable rail assembly 50, the platform 40 can be raised into a confined space further by a distance approximately equal to a length of the vertical rails 78, 92. The vertical distance gained through the use of the narrow space operational mode can eliminate or reduce the need for additional ladders, foot stools, or lift attachments for the platform 40 that may be undesirable for several reasons, including time, stability, and cost. While described extensively in the context of ceiling grid access, the narrow space operational mode is similarly useful in navigating plumbing systems 300 and pipes 302 that are positioned closely together, as depicted in FIGS. 19-20.

The adjustable platform rail assembly can be further transitioned to a transport mode, as depicted in FIG. 12. The transport mode can be reached from both the narrow space operational mode and the confined space mode, and involves folding both of the perimeter assembly 74 and the confined space assembly 76 to stowed positions relative to the lower rail assembly 54. By disengaging the guard rails 84 from the cross rail 94 and disengaging both of the restraining rails 110 from the cross rails 108, each of the vertical rails 78, 92, 104 can rotate about their respective brackets 80, 96, 106 downwardly and inwardly, into the passenger compartment 52 and to their stowed positions. In the transport mode, the overall height of the MEWP 30 is reduced so that the MEWP 30 can travel through doorways and other passages without needing to completely remove or otherwise disassemble the adjustable platform rail assembly 50.

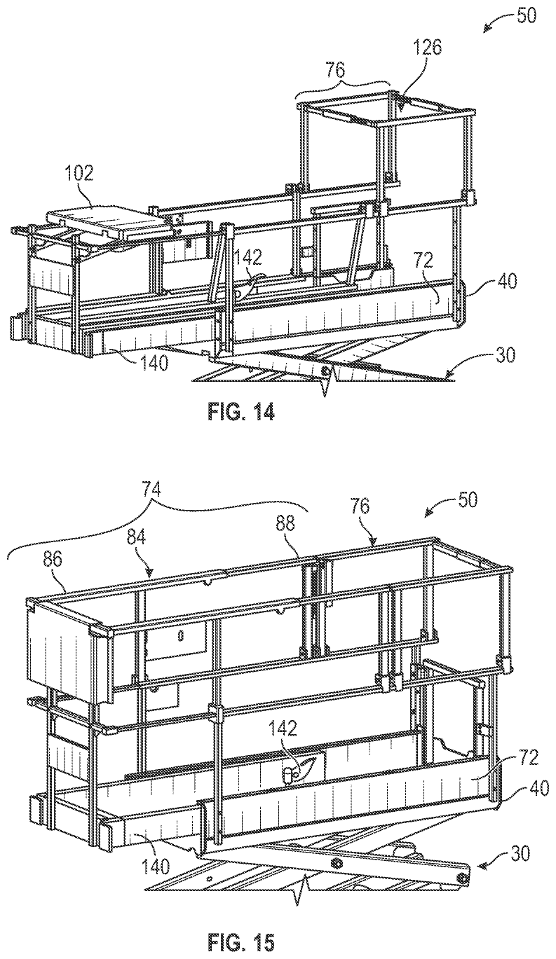

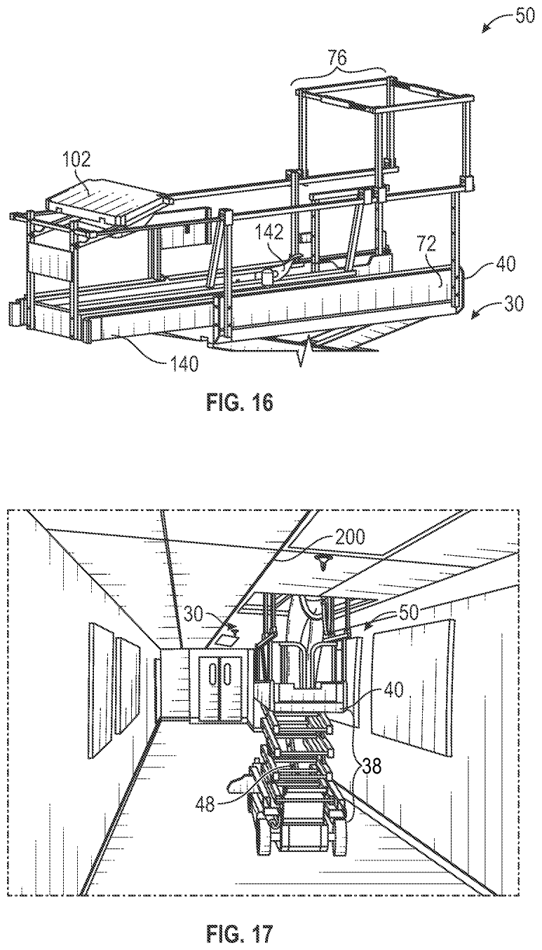

With further reference to FIGS. 13-16, the platform 40 can have an adjustable (e.g., extendable) operator-supporting surface 60 to provide a larger working space and larger passenger compartment 52. The platform 40 is partially defined by a slidable tray 140 that can move between a stowed position (shown in FIG. 1) and several extended positions relative to the floor panels 72 (shown in FIGS. 13-16). Because the guard rails 84 are designed with telescoping geometry, outward movement of the tray 140 pulls the inner arm 88 outward from the outer arm 86 to extend the overall length of the guard rail 84. The cross rails 68 can be provided with a similar telescoping structure so that movement of the tray 140 extends both the lower rail assembly 54 and upper rail assembly 56 outward to continue surrounding the full length of the platform 40. As depicted in FIGS. 14 and 16, the adjustable platform rail assembly 50 can be transitioned to the narrow space operational mode, even with the tray 140 extended outward from the floor panels 72. In some examples, a brake 142 is positioned between the tray 140 and the floor panels 72 to lock the position of the tray 140 relative to the floor panels 72.

Using the foregoing adjustable platform rail assemblies 50 described above, the platform 40 can be reconfigured to reach and work within confined spaces that were previously inaccessible with a standard MEWP. The adjustable platform rail assemblies 50 allow the platform 40 to extend upwardly by an extra 19.25 inches, for example, which can eliminate the need for retrofit devices that include steps or ladders to increase the height of a worker so that he or she can access a work area within a confined space. The adjustable platform rail assembly 50 can be readily retrofit onto an existing MEWP or otherwise provided on a MEWP 30 to provide a lower-cost and less time-consuming alternative to step ladder attachments that are often difficult to attach to the platform 40 and add increased weight that may limit the safe operating height of the MEWP and limit the mobility of the MEWP (e.g., through a doorway).

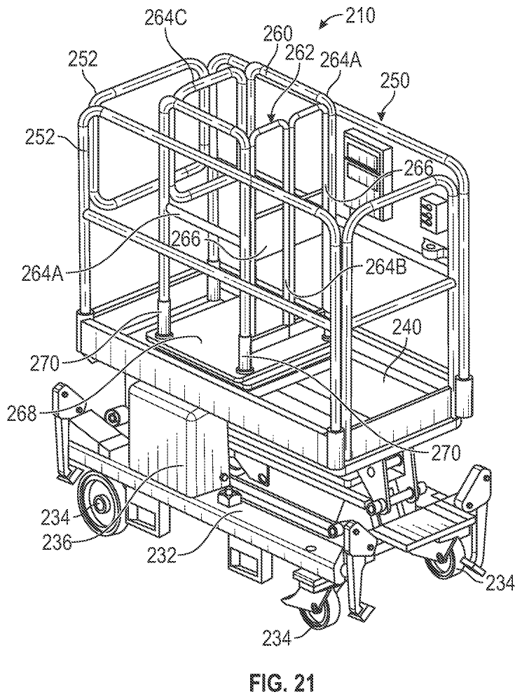

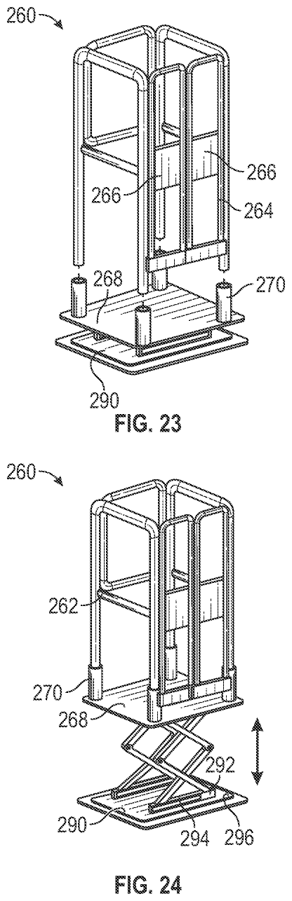

Referring now to FIGS. 21-24, another exemplary MEWP 210 is depicted. Like the MEWP 30, the MEWP 210 includes a chassis 232 supporting a plurality of wheels 234 positioned about the chassis 232. The wheels 234 can once again be driven by a prime mover 236 that is configured to propel the MEWP 210 to a desired location for completing a task. The MEWP 210 includes a retractable lifting mechanism 238 that is coupled to the chassis and supports a platform 240. The retractable lifting mechanism 238 is configured as the retractable lifting mechanism 38, and includes a similar series of linked, foldable support members 42 that are connected to one another and adjustable relative to the chassis 232 using an actuator 48 that is coupled to or otherwise supported by the chassis 232.

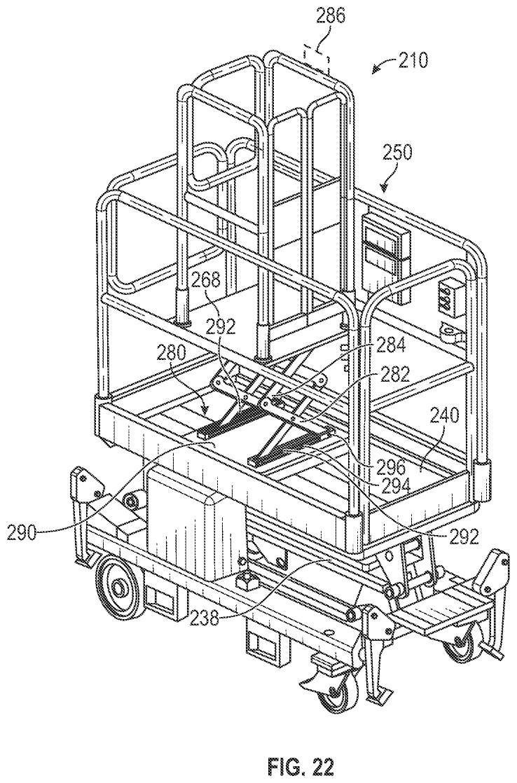

The platform 240 once again supports an adjustable rail assembly 250, which can take the form of or include an accessory, shown as a cage 260. The cage 260 is generally formed as a four-sided enclosure 262 that can receive and support an operator. The cage 260 includes four rails 264 that form a box-shaped enclosure 262. As depicted in FIGS. 21-22, the cage 260 includes two opposing side rails 264A and an entrance rail 264B and brace rail 264C that span between the side rails 264A. In some examples, the side rails 264A are formed of an approximately identical shape and size, while the entrance rail 264B and brace rail 264C differ from one another. For example, the entrance rail 264B can include one or more doors 266 that can rotate to permit selective access into the enclosure 262. In some examples, the doors 266 are configured to rotate inwardly, toward the brace rail 264C. Accordingly, an operator can rotate one or both doors 266 of the entrance rail 264B inward, move into the enclosure 262, and rotate the doors 266 outward to be positioned within the cage 260. The brace rail 264C can be a rectangular or square-shaped tubing that extends between the two side rails 264A. In some examples, the rails 264 of the cage are formed from aluminum or other suitable materials. The rails 264 can each have a maximum height of at least about 1.1 meters, for example, in compliance with ANSI 92.20. In some examples, the rails 264 extend upwardly beyond the rails 252 of the outer portion of the adjustable rail assembly 250.

The cage 260 is received upon and positioned above a base panel 268. The base panel 268 has a generally rectangular shape and is defined by a smooth, planar surface that can support a user. Rail mounts 270 are coupled to (or formed in) and positioned about the base panel 268 to receive or extend into the rails 264 that form the enclosure 262. The rail mounts 270 can take the form of a sleeve-like structure that is mounted to (e.g., welded) or otherwise formed on the base panel 268. The rail mounts 270 include a vertically-extending boss that can either receive or extend into the rails 264 that form the enclosure 262 to removably couple the cage 260 to the base panel 268. The boss can maintain the rails 264 in a vertical position relative to the base panel 268 by surrounding or extending into at least a portion of the rails 264. In some examples, the rail mounts 270 are positioned about a perimeter (e.g., within each corner) of the rectangular base panel 268, such that the outer perimeter of the cage 260 is positioned entirely above the base panel 268. The entire cage 260 can be received within an outer perimeter of the adjustable rail assembly 250, such that the cage 260 can be positioned upon the platform 240 even during normal or standard operating conditions.

The cage 260 can be elevated upwardly, off of the platform 240 using a scissor jack 280. The scissor jack 280 is positioned on the platform 240 and is configured to raise the base panel 268 and cage 260 away from the platform 240 using a series of foldable support members 282 that are raised and lowered using an actuator 284. In some examples, the actuator 284 is a hydraulic cylinder or electric linear actuator that is configured to extend or retract in response to a command received from a controller 286 that can be positioned within or mounted to the cage 260. A user within the cage 260 can interact with a human user interface (HMI) that is mounted to the cage 260, which can command and control the operation of the scissor jack 280 to raise or lower the cage 260 relative to the platform 240.

The scissor jack 280 can be positioned upon or otherwise mounted to a support plate 290 that is positioned on the platform 240. The support plate 290 has a generally rectangular shape and supports two guide rails 292 that extend upwardly from the support plate 290. The guide rails 292 each include a slot 294 and a pin mount 296 that together define the permissible range of motion for the scissor jack 280, which in turn defines the range of permissible movement of the cage 260 relative to the platform 240. A lower or bottom end of the scissor jack 280 is mounted to the guide rails 292, while the upper or top end of the scissor jack 280 is mounted to an underside of the base panel 268.

The scissor jack 280 can be used to move an operator upward, away from the platform and into confined spaces that might otherwise be unreachable by the MEWP 210. As depicted in FIG. 22, the cage 260 can be raised away from the platform 240 by the actuator 284 of the scissor jack 280. The user can control the height of the cage 260 from within the cage 260 using a control panel or remote control that can be positioned upon or otherwise coupled to one of the rails 264 of the cage 260. Because the perimeter of the cage 260 is much smaller than the perimeter of the adjustable rail assembly 240, the cage 260 is able to extend into and reach locations that might otherwise be inaccessible using the adjustable rail assembly 240 alone. Additionally, the cage 260 eliminates the need for additional equipment on the platform 240, like ladders or stepstools that may otherwise be used by an operator to reach or climb into a confined space. The working or usable area on the platform 240 is not sacrificed, as the cage 260 can be moved about the platform 240 so that the entire platform 240 remains usable when the cage 260 is in the stowed position, shown in FIG. 21. The cage 260 can be moved between a first, stowed position shown in FIG. 21 and a second, deployed position shown in FIG. 22.

The positioning of the cage 260 on the platform 240 can also be adjusted to help position the cage 260 relative to a confined area to reduce the amount of time spent trying to position the entire MEWP 210. In some examples, the support plate 290 is configured to slide along the platform 240 to help adjust the position of the cage 260 relative to the platform 240. The support plate 290 can include one or more wheels that can be received within corresponding tracks 298 formed in the base of the platform rail assembly 250. In other examples, the tracks 298 can be formed within the platform 240. In some examples, a position locking or stop mechanism can be incorporated into the support plate 290 to restrict motion of the support plate 290 and cage 260 relative to the platform 240. The position locking or stop mechanism can be controlled using a lever or actuator on the cage 260, for example, which can allow a user to interact with and adjust the positioning of the cage 260 on the platform 240 with ease. In other examples, the position locking mechanism is positioned in a location that would be difficult to reach from within the cage 260 (e.g., on the platform, on the base plate 268, on the support plate 290), so that any accidental unlocking is avoided while an operator is positioned within the cage 260.

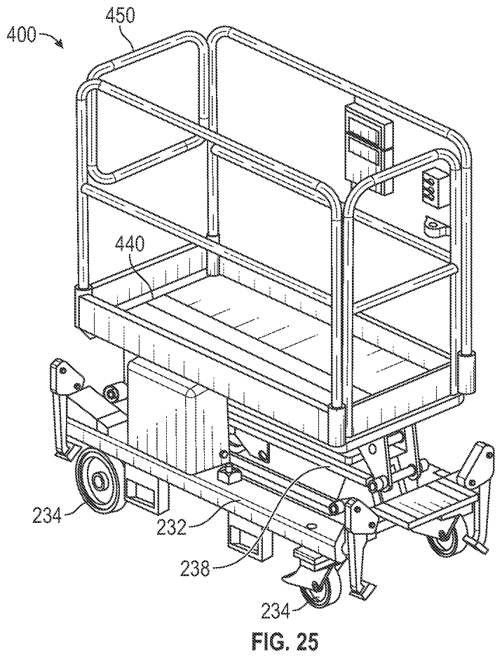

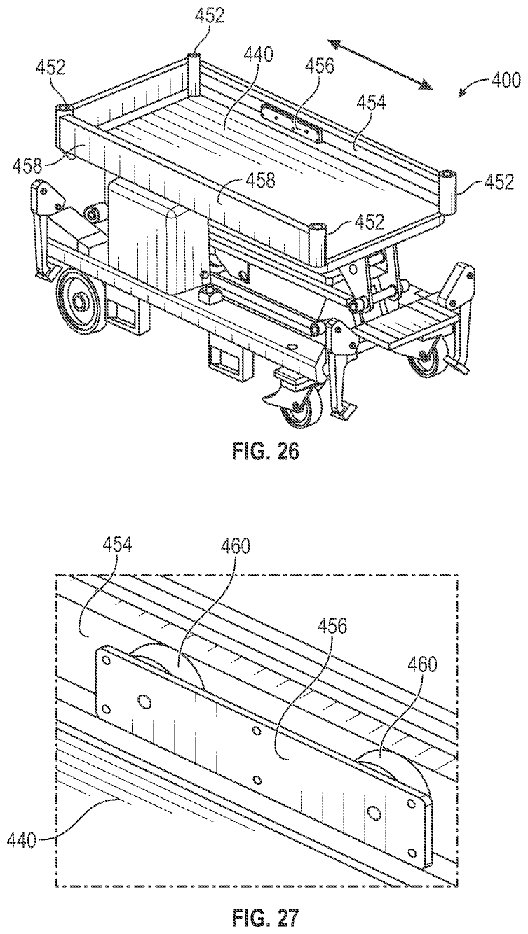

Referring now to FIGS. 25-30, another MEWP 400 is depicted. The MEWP 400 is generally formed with the same components as the MEWP 210, differing only in that the platform 440 and associated adjustable rail assembly 450 are changed. The MEWP 400 includes the chassis 232 that supports a plurality of wheels 234 positioned about the chassis 232. The wheels 234 can once again be driven by a prime mover 236 that is configured to propel the MEWP 400 to a desired location for completing a task. The MEWP 400 includes the retractable lifting mechanism 238, which is coupled to the chassis 232 and supports the platform 440. The retractable lifting mechanism 238 is configured to lower and raise the platform 440 away from the chassis 232.

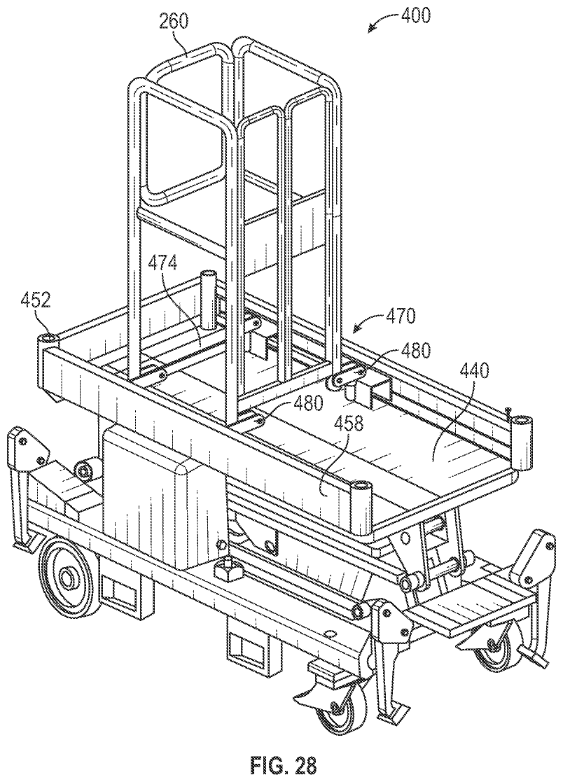

The MEWP 400 includes another adjustable platform rail assembly 450 that can be used to access enclosed or confined spaces. The MEWP 400 is configured to transition between a normal working configuration (shown in FIG. 25) and an enclosed space configuration (shown in FIG. 28). In the normal working configuration, the entire platform 440 can be used by the worker to perform tasks at different elevations. In the enclosed space configuration, the operating space for a worker is reduced to the cage 260.

The MEWP 400 is transitioned to the enclosed space configuration by first removing the adjustable platform rail assembly 450 from the platform 440. The adjustable platform rail assembly 450 can be removed from the platform 440 by lifting the adjustable platform rail assembly 450 upward and outward from a series of pole mounts 452 that are positioned about a perimeter of the platform 440.

With the adjustable platform rail assembly 450 removed from the platform 440 and from the MEWP 400, more generally, the cage 260 can be installed onto the platform 440. Initially, rails 454 and runners 456 can be installed onto the floor panels 458. The rails 454 define a channel that receives wheels 460 of the runners 456, which allows the runners 456 to travel about a length of the platform 440.

With the rails 454 and runners 456 installed, an auxiliary frame assembly 470 can be installed onto the platform 440. The auxiliary frame assembly 470 includes two outer channels 472 that can be mounted to the runners 456. The channels 472 can be mounted to the runners 456 using one or more fasteners, for example. In other examples, the channels 472 are configured to hang from the runners 456, so that the channels 472 are suspended from the runners 456. With the channels 472 coupled to the runners 456, the entire auxiliary frame assembly 470 can move along the rails 454 and along the entire length of the platform 440. In some examples, a brace rail 474 extends between the channels 472 to couple the channels 472 together and form a singular support structure.

The channels 472 support and receive mounts 476 that are configured to receive a stub rails 478, which are used to couple the cage 260 to the auxiliary frame assembly 470. The stub rails 478 are coupled to the cage 260 using a pin and bracket connection. The brackets 480 can be formed as two parallel plates 482 that are pin connected at or near the bottom of the rails 264 and at or near the top of the stub rails 478. Pins 484 extend through each of the stub rails 478 and the rails 264 to secure the plates 482 to the cage 260 and the stub rails 478.

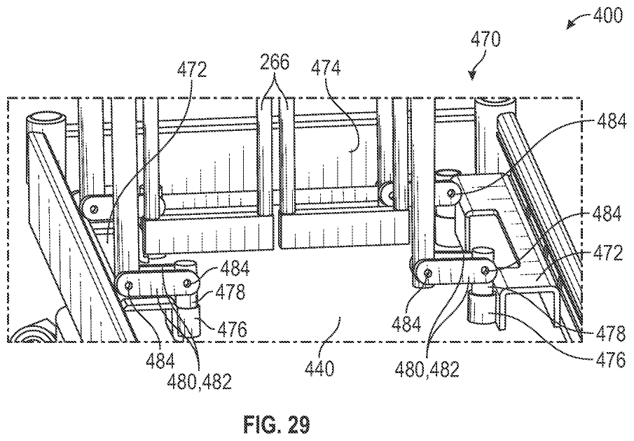

The pin connection between the stub rails 478 and the rails 264 allows the cage 260 to rotate between two different and offset positions, which can help to position the cage 260 relative to an enclosed space. By being able to rotate the cage 260 about the pins 484 and relative to the stub rails 478, the entire cage 260 can move between a first position offset toward (e.g., adjacent to) one of the floor panels 458, as shown in FIG. 29, and a second position offset toward an opposite floor panel 458. To transition between the first position and the second position, the cage 260 can be lifted and rotated laterally, which causes the plates 482 of the bracket 480 to rotate about the pins 484. Once the plates 482 cross a center axis (e.g., when the rail 264 and the stub rail 478 are not in perfect vertical alignment), the cage 260 will naturally continue to rotate toward the second position and fall into alignment in the second position, resting on the opposite channel 472. In some examples, the top surface of the channels 472 can serve as a rotational stop which can help to position the cage 260 in either of the first or second position.

The pin-and-bracket connection and the runners 456 allow the cage 260 to move relative to the platform 440 along two perpendicular axes, which can help promote adjustability of the cage 260. By allowing the cage 260 to move along multiple axes, small and sometimes time consuming positioning processes do not need to be performed by the entire MEWP 400, and can instead be reduced to only the cage 260. While traditional systems may require perfect alignment of the entire MEWP 400 relative to the confined space above, the auxiliary frame assembly 470 avoids these downfalls by providing enhanced adjustability in multiple directions, which can even be performed by a user from within the cage 260. Similarly, by allowing the cage 260 to slide about the platform 440, multiple ceiling openings may be serviced without needing to move the MEWP 400.

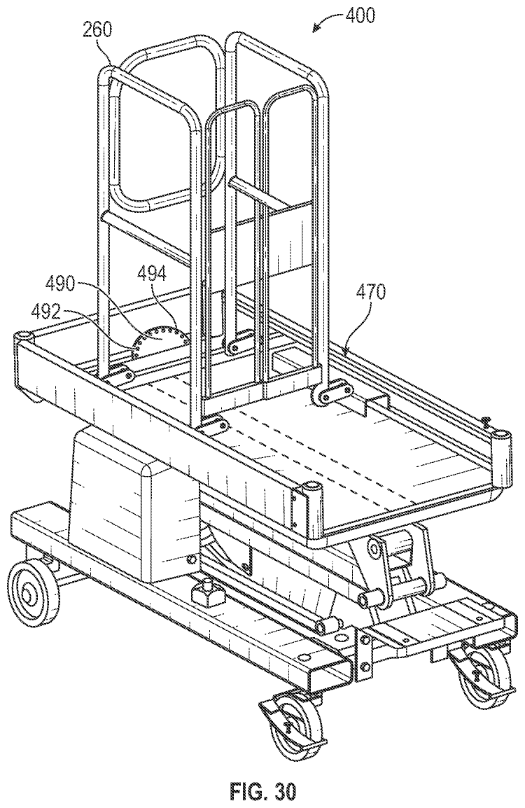

In some examples, and as shown in FIG. 30, the auxiliary frame assembly 470 further includes a position lock 490. The position lock 490 can be used to secure the auxiliary frame assembly 470 in a position on the platform 440. The position lock 490 can include a spring-loaded pin 492 that can selectively engage and release different holes within a locking plate 494. The locking mechanism 490 can be used to secure the auxiliary frame assembly 470 along the platform, as well as in intermediate positions between the first and second position that may adjust a height of the cage 260. In each configuration, however, the cage 260 remains at a height that complies with suitable regulations (e.g., ANSI 92.20).

Like the MEWPs 30, 210, the MEWP 400 is able to maneuver an operator into a confined space better than a traditional lift. By reducing the perimeter of the rail assembly so that only the cage 260 extends upward from the platform 440, the cage 260 can be raised higher, into an enclosed space so that various tasks can be performed. The systems disclosed allow a MEWP to better perform tasks that might otherwise require additional equipment to perform. Time-consuming positioning processes can be avoided, and overall access to work areas is significantly improved. The cage 260 is designed so that the entire cage 260 can fit within a standard 600 mm×600 mm ceiling tile.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the adjustable platform rail assembly as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. An adjustable platform rail assembly comprising:
a lower rail assembly extending away from a platform to define a passenger compartment; and
an upper rail assembly coupled to the lower rail assembly and extending upwardly away from the lower rail assembly;
wherein the upper rail assembly includes:
a perimeter rail assembly rotatably coupled to the lower rail assembly and extending partially around a first portion of the platform; and
a confined space assembly rotatably coupled to the lower rail assembly and extending entirely around a second portion of the platform forming a confined space perimeter, the first portion of the platform being larger than the second portion,
wherein the upper rail assembly is movable between (a) a first configuration in which the perimeter rail assembly and the confined space assembly are in an extended position and the upper rail assembly surrounds the passenger compartment, and (b) a second configuration in which the perimeter rail assembly is in a collapsed position, the confined space assembly is in an extended position, and the upper rail assembly surrounds a subset of the passenger compartment.

2. The adjustable rail platform assembly of claim 1, wherein each of the perimeter rail assembly and the confined space assembly are movable between an extended position extending upwardly away from the lower rail assembly and a collapsed position folded inward, into the passenger compartment.

3. The adjustable rail platform assembly of claim 1, wherein the confined space assembly includes a plurality of cross rails extending around the passenger compartment and a first restraining rail rotatably coupled to one of the plurality of cross rails and extending across the passenger compartment to another of the plurality of cross rails to form the confined space perimeter.

4. The adjustable rail platform assembly of claim 1, wherein the upper rail assembly includes a plurality of vertical rails, and wherein the perimeter rail assembly includes a first subset of the plurality of vertical rails and the confined space assembly includes a second subset of the plurality of vertical rails.

5. The adjustable platform rail assembly of claim 4, wherein the perimeter rail assembly is defined by a third subset of the plurality of vertical rails extending upwardly away from one side of the lower rail assembly and a fourth subset of the plurality of vertical rails extending upwardly away from an opposite side of the lower rail assembly, wherein a first guard rail extends between and is coupled to the third subset of the plurality of vertical rails and wherein a second guard rail extends between and is coupled to the fourth subset of the plurality of vertical rails.

6. The adjustable platform rail assembly of claim 5, wherein the first guard rail and the second guard rail are each comprised of an outer arm and an inner arm slidably received within the inner arm.

7. The adjustable platform rail assembly of claim 6, wherein the first guard rail and the second guard rail are each releasably coupled to a cross rail of an end section assembly, the end section assembly being hingedly coupled to the lower support assembly.

11. The adjustable platform rail assembly of claim 1, wherein the confined space assembly is further defined by a second restraining rail extending rotatably coupled to one of the first cross rail and the second cross rail and extending across the passenger compartment, from the first cross rail to the second cross rail.

12. The adjustable platform rail assembly of claim 1, wherein the adjustable platform is capable of being coupled to a platform assembly of a scissor lift.

13. The adjustable platform rail assembly of claim 1, wherein the perimeter rail assembly includes a two side assemblies and an end assembly comprising a fifth subset of the plurality of vertical rails, wherein the end assembly is coupled to each of the two side assemblies, and wherein each of the side assemblies and the end assembly are hingedly coupled to the lower rail assembly via the brackets and foldable inward, into the passenger compartment, to configure the upper rail assembly into the second position.

14. A platform assembly comprising:
a platform;
a lower rail assembly coupled to and extending away from the platform to define a passenger compartment; and
an upper rail assembly coupled to the lower rail assembly and extending upwardly away from the lower rail assembly;
wherein the upper rail assembly includes:
a perimeter rail assembly extending around a first portion of the platform; and
a confined space assembly extending around a second portion of the platform,
wherein the perimeter rail assembly includes a pair of side assemblies and an end assembly, wherein each of the side assemblies and the end assembly are hingedly coupled to the lower rail assembly and foldable inward, toward the passenger compartment, and wherein a portion of the end assembly is wider than the lower rail assembly.

15. The platform assembly of claim 14, wherein the upper rail assembly is coupled to the lower rail assembly and is movable between a first position wherein the upper rail assembly defines an upper perimeter defined by a first length and a second position wherein the upper rail assembly defines an upper perimeter defined by a second length shorter than the first length.

16. The platform assembly of claim 14, wherein the end assembly comprises a working surface, wherein in a first position the working surface is outside a perimeter of the passenger compartment and wherein in a second position the working surface is inside the perimeter of the passenger compartment.

17. The platform assembly of claim 16, wherein in the second position the working surface is positioned above the lower rail assembly.

18. The platform assembly of claim 16, wherein the working surface comprises a channel configured to engage with a cross rail of the lower rail assembly.

19. An adjustable platform rail assembly for a mobile elevated work platform, the adjustable platform rail assembly comprising:
a lower rail assembly extending away from a platform to define a passenger compartment; and
an upper rail assembly coupled to the lower rail assembly and extending upwardly away from the lower rail assembly, the upper rail assembly including:
a perimeter rail assembly rotatably coupled to the lower rail assembly and extending partially around a first portion of the platform; and
a confined space assembly rotatably coupled to the lower rail assembly and extending entirely around a second portion of the platform forming a confined space perimeter, the first portion of the platform being larger than the second portion,
wherein the upper rail assembly is movable between (a) a first configuration in which the upper rail assembly defines an upper perimeter having a first length corresponding to the perimeter rail assembly and the confined space assembly and (b) a second configuration in which the upper rail assembly defines an upper perimeter having a second length corresponding to the confined space assembly, the second length being shorter than the first length,
wherein the confined space assembly includes a cross rail extending across the passenger compartment to form the confined space perimeter.

20. The adjustable platform rail assembly of claim 19, wherein the first length corresponds with a perimeter surrounding the first portion and the second portion, and the second length corresponds with a perimeter of the second portion.
